(19) United States
(12) Patent Application Publication
(10) Pub. No.: US 2014/0227425 A1
(43) Pub. Date: Aug. 14, 2014

(54) PROCESS FOR MANUFACTURING AN ANIMAL FEED OR FOODSTUFF AND A PRODUCT MANUFACTURED BY THAT PROCESS

(71) Applicant: Mars Incorporation, McLean, VA (US)

(72) Inventors: Johannes P. Schlebusch, Thedinghausen (DE); Carsten Graeber, Kirchlinteln (DE)

(21) Appl. No.: 14/345,930

(22) PCT Filed: Sep. 19, 2012
(86) PCT No.: PCT/EP2012/003897

§ 371 Date: Mar. 19, 2014

(30) Foreign Application Priority Data
Sep. 19, 2011 (DE) 10 2011 113 776.2

(51) Int. Cl. A23K 1/10; A23L 1/325; A23L 1/317

(52) U.S. Cl. CPC A23K 1/103; A23K 1/10; A23L 1/317; A23L 1/3255
USPC 426/643; 426/641

(57) ABSTRACT

The present invention relates to a process for manufacturing an animal feed or foodstuff comprising the steps of: (i) providing at least one first stream of material comprising a meat and/or fish emulsion, and at least one second stream of material comprising at least one gel-forming and/or gel-like substance, (ii) preferably continuously feeding the second stream of material into the first stream of material in the form of layers and/or coarsely dispersed in the form of droplets, (iii) solidifying at least the first stream of material contained in the combination of materials obtained in step (ii), and (iv) cutting the combination of materials obtained in step (iii) into slices with a thickness of about 0.6-6 mm, preferably 0.8-4 mm, even more preferably 0.9-3 mm; and also an animal feed or foodstuff manufactured by that process.

The present invention relates to a process for manufacturing an animal feed or foodstuff and a product manufactured by that process.

In the animal feed and food industry, a problem which arises in a variety of ways is how to manufacture simply and efficiently products which in particular have the appearance of natural or original pieces of meat or fish, but which are manufactured from smaller meat and fish offcuts or meat or fish-like components.

In this connection, products are well-known which are manufactured using meat or fish emulsions.

Meat and fish emulsions are understood to mean materials which preferably contain meat and/or fish raw materials, but in addition may also contain a certain amount of meat and/or fish by-products such as offal, meat and fish remnants, fish parts, fish offcuts and the like.

The general problem in this connection is, that in the course of processing these raw materials, the original texture of the materials used is almost completely lost during the inevitable sterilisation step. This texture and appearance are, however, key factors for the acceptance by people and animals of the foodstuff and animal feed produced.

EP1047307B1, for example, discloses a process for manufacturing an animal feed or foodstuff in which the different streams of material are placed one on top of the other in layers and then subjected to process conditions under which one stream of material liquefies and another solidifies.

DE102006031794A1 discloses a process for manufacturing an animal feed or foodstuff in which a second stream of material is dispersed in the first stream of material in laminar fashion, so that the second stream of material is distributed in the first stream of material in the form of droplets and the combined streams of material are then discharged via a nozzle and solidified.

The animal feed or foodstuffs produced according to processes from the state of the art are, however, still not satisfactory with regard to the fibrous meat or fish structure/texture. It is also frequently the case that a difference is noticed compared to the natural or fibrous texture of natural original pieces of meat and fish and their shape and/or size distribution.

It is therefore an object of the present invention to provide a process for manufacturing animal feed or foodstuffs which overcomes the disadvantages from the state of the art, and which in particular provides products which at least come very close to natural meat and fish pieces in terms of texture, appearance and shape.

In addition, it is an object to provide an animal feed or foodstuff manufactured according to the process.

The first problem is solved by a process for manufacturing an animal feed or foodstuff comprising the steps of:
(i) providing at least one first stream of material comprising a meat and/or fish emulsion, and at least one second stream of material, comprising at least one gel-forming and/or gel-like substance,
(ii) preferably continuously feeding the second stream of material into the first stream of material in the form of layers and/or coarsely dispersed in the form of droplets,
(iii) solidifying at least the first stream of material contained in the combination of materials obtained in step (ii), and
(iv) cutting the combination of materials obtained in step (iii) into slices with a thickness of about 0.6-6 mm, preferably 0.8-4 mm, even more preferably 0.9-3 mm.

Feeding the second stream of material coarsely dispersed in the form of droplets, as described in step (ii), is preferably understood to mean dispersing, during which the second stream of material is at least partially incompletely mixed into the first stream of material, so that the second stream of material spreads out in the first stream of material in the form of droplets with a size of at least 0.3 to 8 mm These droplets can still be seen with the naked eye in the first stream of material. If the droplet diameter is less than or equal to 0.1 mm, it is assumed that there has been a complete blending of the streams of material.

For the process of the invention, it is preferable for the second stream of material to be fed coarsely dispersed in the form of droplets into the first stream of material and for these droplets then to be withdrawn in a step (iia) through a nozzle, preferably a slotted nozzle or a screen plate, so that it basically likewise assumes a layer-like shape within the first stream of material.

It is preferable for the second stream of material to be fed into the first stream of material in step (ii) in spiral layers.

It is preferred that in the combination of materials obtained in step (iii), the second stream of material is less solid than the first stream of material.

It is particularly preferable for the second stream of material to comprise a viscous gel, a second meat and/or fish emulsion with texture characteristics different from those of the first stream of material, a gelatine-based liquid and/or a fat/oil mixture, the viscous gel preferably containing a gel-forming substance from the group comprising carboxymethyl cellulose, guar gum and other hydrocolloids, aspic, gelatine and/or broth, the fat/oil mixture comprising a substance selected from margarine, butter, butter fat, drawing grease, palm oil and/or beef suet.

As the second stream of material, it is particularly preferred to use a viscous gel, the viscosity of which may be between 10,000 mPas and 500,000 mPas, measured with a Brookfield viscometer RVDVIII, spindle 7, 20 r.p.m., temperature 20° C.

In accordance with the invention, it is preferably also proposed that the second stream of material comprises vegetable fibres, preferably wheat fibres, oat fibres, cellulose fibres, fibres in the form of powders, such as cellulose powder, sugar beet chip powder or chicory chip powder or mixtures thereof.

It is also proposed that the layers of the second stream of material are preferably 0.2 to 6 mm thick and are spaced apart from one another by 0.5 to 20 mm and/or that when the second stream of material is fed in spirally, the spirals are arranged to be partially overlapping.

As already explained, the second stream of material is preferably fed into the first stream of material in spiral layers. Here, the space between individual spirals of the second stream of material is important in determining whether the intention is to manufacture a more fish-like or meat-like animal feed or foodstuff. More irregular-sized pieces, which consumers prefer, can be obtained if a certain distance is maintained between the individual spirals, since the thinly cut slices do not then have any predetermined breaking points.

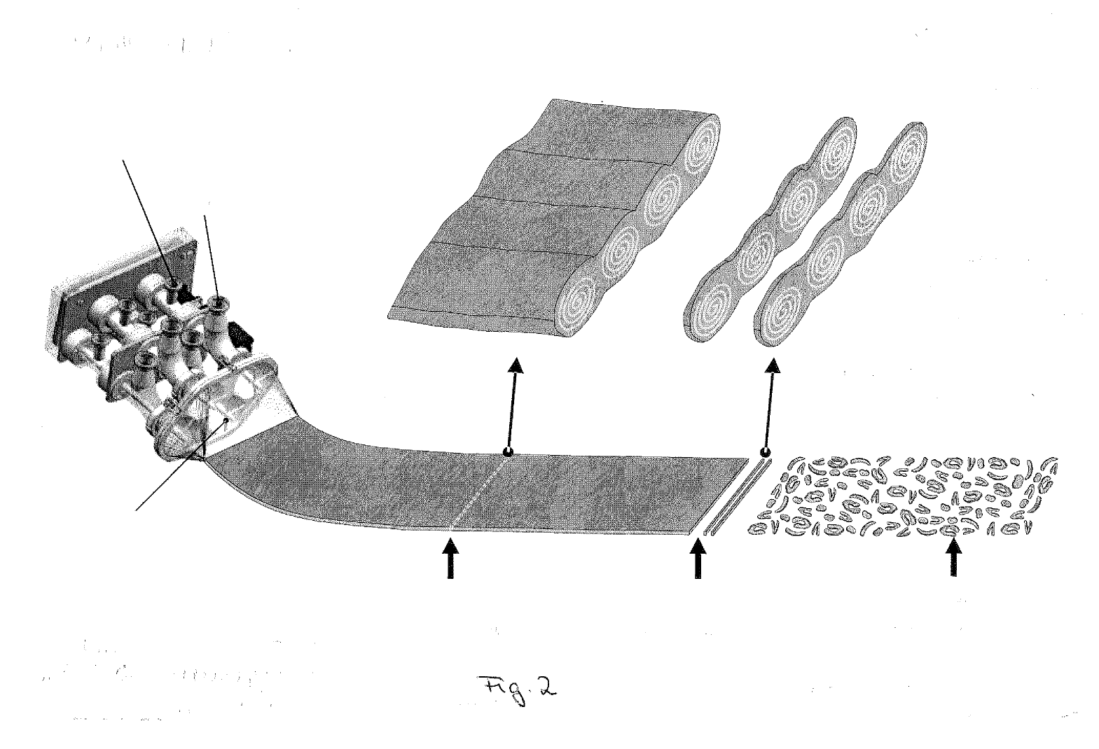

When preparing a fish-like animal feed or foodstuff, an attempt can be made to eliminate the gap between the spirals by partial overlapping so that the structure obtained is present, as far as possible, over the entire width of the material, see also FIG. 2 below.

With thicker slices in step (iv), it is then possible in the case of fish-like animal feed or food-stuffs to produce tuna analogues, whereas longitudinal cuts can be used, for example, to produce other fish analogues with the patterns of myosepta typical of fish fillets. It is also possible to obtain large fish fillets with typical patterns of myosepta by means of additional horizontal cuts, such as half-way down the material discharged.

It is particularly preferable that the second stream of material fed in in the form of droplets in a coarsely dispersed manner in step (ii) should have a droplet diameter which is at least as large as the thickness of the slice obtained in step (iv).

In a particularly preferred embodiment, in step (ii), the second stream of material is introduced into the first stream of material by means of an apparatus comprising a hollow shaft, into which the second stream of material is introduced at an input end thereof and is delivered to an exit end, the hollow shaft being substantially concentrically surrounded, at least at the exit end, by a tube via which the first stream of material is transported to the exit end of the hollow shaft, and at the exit end of the hollow shaft, inside the tube, the second stream of material is fed into the first stream of material via a distribution means.

It is also preferable for the distribution means to be an impeller wheel.

It is also proposed that in step (ii), the second stream of material is fed into the first stream of material in a coarsely dispersed manner by means of a static mixer.

In accordance with the invention, a process is particularly preferred which has an additional process step (iia), wherein the combination of materials obtained in step (ii) is discharged through a nozzle or screen plate.

After process step (ii), the combination of materials obtained can be solidified directly, for example if it is solidified by means of resistance heating. If, however, it is intended to solidify the combination of materials obtained in a steam tunnel for example, it is advisable to discharge the combination of materials obtained in step (ii) in a subsequent step (iia) through a nozzle or screen plate in order to provide the combination of materials obtained in a way that facilitates uniform heat treatment/gelling of the proteins. Especially if fish analogues are to be manufactured, it is advisable to shape or withdraw the inclusions of the second stream of material contained in the first stream of material using a flat nozzle or screen plate, in order to obtain a fish fillet-like structure after the final cutting of the solidified combination of materials.

Apart from the possible processes described above for introducing the second stream of material into the first stream of material, a person skilled in the art is well aware of other alternatives. An alternative of this kind also includes such processes as the one known from EP 1 047 307 B1.

Further alternatives for creating stratified layers of the first and second streams of material, where the material of the second stream of material is preferably intended to serve as a breaking point during the manufacture of the animal feed or foodstuff, may be:
a) creating alternating layers of the materials of the first and second streams of material and subsequently conveying them through a gap.
b) Rapidly conveying the first and second streams of material through two parallel carpet nozzles (slots), where the stratified stream of material “ripples” in the process. The same can also be achieved by weaving two corresponding material nozzles from left to right. Subsequent conveying through a slot, such as is described in EP 1 047 307 B1 for example, then creates the stratification ultimately required.
c) By shooting or rapidly pumping the second stream of material into the first stream of material substantially at a right angle, as a result of which corresponding layers are created when flowing through a screen plate.
d) Using rotating or alternating nozzles/valves, the first stream of material and the second stream of material are pumped into an apparatus alternately. When conveyed through a screen plate the desired layers are created.

It can also be contemplated that this nozzle is a slotted nozzle.

It is particularly preferred that the first and second streams of material are used in a weight ratio of 50:50 to 95:5, based on the total amount of the first and second streams of material, preferably in a weight ratio of 80:20 to 90:10, more preferably 85:15.

The solidification in step (iii) is preferably achieved by applying heat, preferably under sterilising conditions.

The first stream of material may additionally comprises fibrous material and/or cereal flour.

The invention also relates to an animal feed or foodstuff which can be obtained by a process in accordance with the invention.

The present invention is based on the surprising finding that the process of the invention allows an animal feed or foodstuff to be manufactured which is very similar in its texture and appearance to natural or original pieces of meat or fish. The animal feed or foodstuffs manufactured by the process of the invention look very natural, have a fibrous texture and comprise pieces of very varied sizes and shapes, so that consumers' expectations regarding such products can be satisfied.

Furthermore, the animal feed or foodstuffs can be manufactured in an extremely simple and inexpensive manner with the process of the invention.

A process in accordance with the invention is particularly preferable in which the second stream of material, after solidification in step (iii), is less solid than the first stream of material. The second stream of material is preferably still liquid or is of lower viscosity relative to the first stream of material.

The second stream of material introduced into the first stream of material basically serves to provide breaking points at which, after the cutting in step (iv), the product manufactured can disintegrate into smaller fragments.

An aspect of crucial importance for the process of the invention is that after solidification in step (iii), the material obtained is cut up into very thin slices with a thickness of 0.6 to 6 mm. As a consequence of this, the arrangement of layers of gel inside the solidified meat or fish emulsion means that these thin slices disintegrate incompletely wherever the layers of gel were located. The result of this is that individual pieces of the animal feed or foodstuff are obtained which have a very natural appearance, are very fibrous and are irregular in shape. If the slices are less than 0.6 mm thick, it is difficult to cut up the solidified stream of material, whereas if the slices are more than 6 mm thick, the incomplete disintegration at the layers of gel does not take place.

It is particularly preferable for the combination of materials obtained after step (ii) to be arranged in the form of a billet which, as already described above, can preferably also be discharged through a nozzle or screen plate. In step (iv), such a billet can then be cut up into thin slices in any way desired. No importance needs to be attached to a cutting angle relative to the direction of discharge of the billet; cutting may, for example, be carried out substantially perpendicularly to the direction of discharge, or at an angle of about 45° or parallel to the direction of discharge.

Incomplete disintegration of the animal feed or foodstuff manufactured in accordance with the invention is intended to mean disintegration which does not occur at all the layers of gel, which would thus lead to pieces of substantially uniform size and hence to a narrow size distribution, but rather disintegration that leads to pieces of a wide range of sizes and hence to a broad size distribution. This is naturally also explained below in connection with the example described there.

Further features and advantages of the process of the invention will become clear from the following detailed description, in which one embodiment of the invention is illustrated by way of example, with reference to the attached drawing, in which

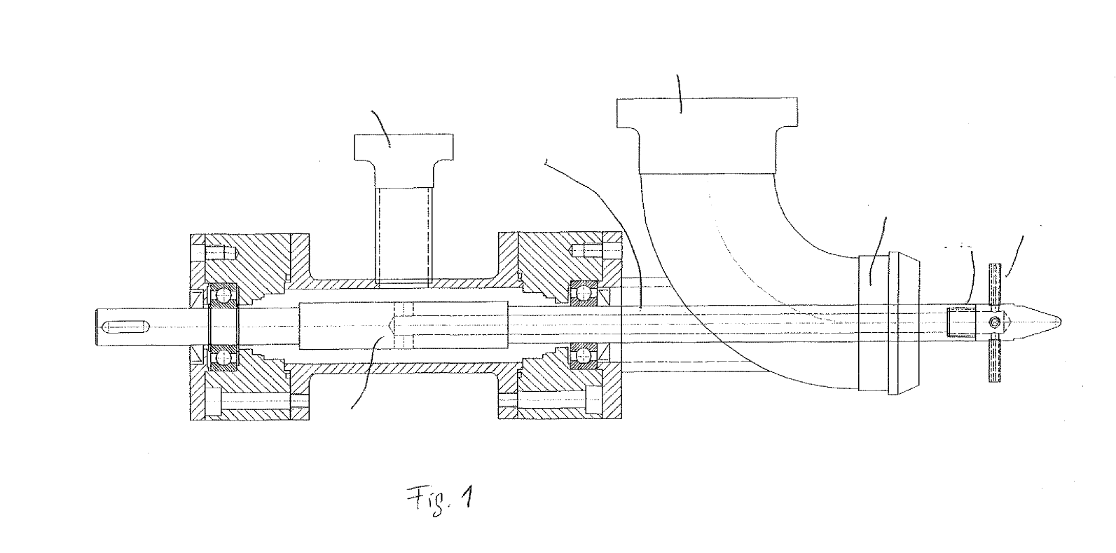

FIG. 1 schematically shows an apparatus for carrying out the process of the invention, and

FIG. 2 is a simplified illustration which likewise shows an apparatus for carrying out the process of the invention, especially with the process steps (ii) to (v)

As first and second streams of material for carrying out the process of the invention, it is possible to use ones which are known from DE102006031794A1, for example. An apparatus suitable for carrying out the process of the invention is shown in FIG. 1. When this apparatus 1 is used, a second stream of material is delivered via a feed apparatus 2 in a hollow shaft 3 at an input end 4 of the hollow shaft 3 and fed in the direction of an exit end 5 of the hollow shaft 3. Via a further feed apparatus 6, a first stream of material is fed into a tube 7 which substantially concentrically surrounds the hollow shaft 3 at least in the area of the discharge end 5 and beyond. The first stream of material is guided through the tube 7. For illustration purposes, the tube 7 is not shown projecting beyond the exit end 5 of the hollow shaft 3 in FIG. 1. It is, however, obvious to any person skilled in the art that that tube 7 must project beyond the exit end 5 of the hollow shaft 3. At or shortly after the exit end 5 of the hollow shaft 3 is disposed a distribution means 8, preferably an impeller wheel. When the impeller wheel 8 is turned, a second stream of material arriving at the exit end 5 is introduced into the first stream of material substantially spirally. The thickness and spacing of the layers of the second stream of material can be adjusted by means of an appropriate choice of impeller wheel and its speed of rotation. Via the tube 7, the product obtained in accordance with the invention by introducing the second stream of material can be further processed, by first discharging the product through a nozzle. The nozzle used for this purpose may, for example, have cross-sections of the kind shown in FIG. 3 of DE102006031794.

FIG. 2 shows a further general embodiment of an apparatus for carrying out the process of the invention. Here, first and second streams of material are in each case delivered via four feed apparatuses 2 or feed apparatuses 6 to an apparatus 9, which can then be processed, as described with regard to FIG. 1, via distribution means 8, of which there are a total of four in this case. After the second stream of material has been introduced into the first stream of material, the combined stream of material is preferably discharged via a slotted nozzle 10 and then delivered to a solidification apparatus (not shown). This solidification apparatus may, for example, be a steam tunnel, in which the product is preferably also sterilised. More extensive and final sterilisation of the animal feed and foodstuff manufactured may, however, also be carried out after packing, for instance also together with a gravy. As can be seen from the combined stream of material shown in cross-section form in FIG. 2, a total of four impeller wheels are provided for introducing the second stream of material into the first stream of material. Those four spiral-shaped second streams of material are not arranged to overlap, so that in the course of the disintegration that occurs during slicing, pieces of very varying sizes are obtained; for example, the regions of the first stream of material in which no second stream of material has been introduced do not disintegrate at all, so that it is possible to speak in general of the “incomplete” disintegration of a stream of material of this kind. It is easy for a person skilled in the art to understand that the arrangement of the second streams of material introduced in a spiral shape, e.g. through the degree of overlapping or not, the distance between the individual layers and the thickness the layers of the second stream of material, makes it possible to obtain pieces varying widely in size and thus also a wide size range distribution. FIG. 2 shows a cross-section through the combined streams of material after solidification in step (iv), but before slicing. The second stream of material 11, introduced in a spiral-shaped layer structure, can clearly be recognised inside a first stream of material 12.

The combined stream of material solidified in the solidification apparatus is then cut, substantially perpendicularly to the discharge direction, into thin slices with a thickness of 0.6 to 6 mm, as can likewise be seen from FIG. 2. The slices cut in this way can be further processed, such as by being transported further on a conveyor-belt. The thin nature of these slices means that during further transport, they disintegrate incompletely at the layers of gel, ultimately resulting in pieces of meat or fish 13 which are very similar in appearance and texture to natural pieces of meat or fish.

After the thin slices have disintegrated incompletely, the pieces of product obtained can be further processed, such as packed and then sterilised.

The features of the invention disclosed in the above description and in the claims and drawing can be essential to implementing the invention in its various embodiments both individually and in any combination.

2-16. (canceled)

17. A process for manufacturing an animal feed or foodstuff, comprising the steps of:
a. providing at least one first stream of material comprising a meat and/or fish emulsion, and at least one second stream of material comprising at least one gel-forming and/or gel-like substance,
b. preferably continuously feeding the second stream of material into the first stream of material in the form of layers and/or coarsely dispersed in the form of droplets,
c. solidifying at least the first stream of material contained in the combination of materials obtained in step (ii), and
d. cutting the combination of materials obtained in step (iii) into slices with a thickness of about 0.6-6 mm, preferably 0.8-4 mm, even more preferably 0.9-3 mm.

18. The process as claimed in claim 17, characterised in that the second stream of material is fed into the first stream of material in step (ii) in spiral layers.

19. The process as claimed in claim 17, characterised in that in the combination of materials obtained in step (iii), the second stream of material is less solid than the first stream of material.

20. The process as claimed in claim 17, characterised in that the second stream of material comprises a viscous gel, a second meat and/or fish emulsion with texture characteristics different from those of the first stream of material, a gelatine-based liquid and/or a fat/oil mixture, the viscous gel preferably containing a gel-forming substance selected from the group consisting of carboxymethyl cellulose, guar gum and other hydrocolloids, aspic, gelatine, broth, and mixtures thereof; the fat/oil mixture comprising a substance selected from the group consisting of margarine, butter, butter fat, drawing grease, palm oil, beef suet, and combinations thereof.

21. The process as claimed in claim 17, characterised in that the second stream of material comprises vegetable fibres, preferably wheat fibres, oat fibres, cellulose fibres, fibres in the form of powders, such as cellulose powder, sugar beet chip powder or chicory chip powder or mixtures thereof.

22. The process as claimed in claim 17, characterised in that the layers of the second stream of material are 0.2 to 6.0 mm thick and are spaced apart from one another by 0.5 to 20 mm and/or that when the second stream of material is fed in spirally, the spirals are arranged to be partially overlapping.

23. The process as claimed in claim 17, characterised in that the second stream of material fed in in step (ii) in the form of droplets in a coarsely dispersed manner has a droplet diameter which is at least as large as the thickness of the slice obtained in step (iv).

24. The process as claimed in claim 17, characterised in that, in step (ii), the second stream of material is fed into the first stream of material by means of an apparatus comprising a hollow shaft, into which the second stream of material is introduced at an input end thereof and is delivered to an exit end, the hollow shaft being substantially concentrically surrounded, at least at the exit end, by a tube via which the first stream of material is transported to the exit end of the hollow shaft, and at the exit end of the hollow shaft, inside the tube, the second stream of material is introduced into the first stream of material via at least one distribution means.

25. The process as claimed in claim 24, characterised in that the distribution means is an impeller wheel.

26. The process as claimed in claim 17, characterised in that in step (ii), the second stream of material is fed into the first stream of material in a coarsely dispersed manner by means of a static mixer.

27. The process as claimed in claim 17, characterised in that the first and second streams of material are used in a weight ratio of 50:50 to 95:5, based on the total amount of the first and second streams of material, preferably in a weight ratio of 80:20 to 90:10, more preferably 85:15.

28. The process as claimed in claim 17, characterised in that the solidification in step (iii) is performed by applying heat, preferably under sterilising conditions.

29. The process as claimed in claim 17, characterised in that the first stream of material additionally comprises fibrous material and/or cereal flour.

30. The process as claimed in claim 17, characterised by an additional process step (iia), wherein the combination of materials obtained in step (ii) is discharged through a nozzle or screen plate.

31. An animal feed or foodstuff obtainable by the process claimed in any of the preceding claims.
